(19) United States
(12) Patent Application Publication
(10) Pub. No.: US 2014/0089051 A1
(43) Pub. Date: Mar. 27, 2014

(54) METHODS AND APPARATUS TO ALIGN PANELIST DATA WITH RETAILER SALES DATA

(71) Applicants: Frank Piotrowski, Arlington Heights, IL (US); Ludo Daemen, Duffel (BE); Christophe Koell, Brussels (BE); Axel Tenbusch, Friedberg (DE); Vippal Savani, Oxfordshire (GB)

(72) Inventors: Frank Piotrowski, Arlington Heights, IL (US); Ludo Daemen, Duffel (BE); Christophe Koell, Brussels (BE); Axel Tenbusch, Friedberg (DE); Vippal Savani, Oxfordshire (GB)

(21) Appl. No.: 13/837,746

(22) Filed: Mar. 15, 2013

Related U.S. Application Data
(60) Provisional application No. 61/705,379, filed on Sep. 25, 2012.

(51) Int. Cl. G06Q 30/02

(52) U.S. Cl. CPC G06Q 30/0205
USPC 705/7.34

(57) ABSTRACT

Methods and apparatus are disclosed to align panelist data with retailer sales data. An example method includes calculating a panelist reporting period for a panelist dataset having a first number of occasions, the panelist dataset having a household resolution, applying trip weights to a retailer dataset, the retailer dataset including a second number of occasions during a market research reporting period, the retailer dataset having a trip resolution, and minimizing a gap between the household resolution and the trip resolution.

### RELATED APPLICATION

This patent claims priority to U.S. Application Ser. No. 61/705,379, which was filed on Sep. 25, 2012, and is hereby incorporated herein by reference in its entirety.

### FIELD OF THE DISCLOSURE

This disclosure relates generally to market research, and, more particularly, to methods and apparatus to align panelist data with retailer sales data.

### BACKGROUND

In recent years, panelist data has been used by market researchers to identify demographic information associated with purchase activity. Typically, consumers associated with households are selected as panelists based on any number of demographic factors such as, but not limited to, income, family size, age of household representative (e.g., main income earner, head of household), ethnicity, employment status and location. Selected panelists are expected to comply with one or more reporting guidelines, such as scanning purchases made during one or more shopping trips.

In addition to panelist data, market researchers may acquire and review retail sales information from one or more merchants/retailers. In some examples, the retail sales information includes instances of purchases identified after a product bar code has been scanned. While the reported demographic information identifies details about the consumer, the retail sales information identifies details about a volume or quantity of sales associated with the retailer. In some examples, the retail sales information may identify instances of sales trends.

### BRIEF DESCRIPTION OF THE DRAWINGS

FIG. 1 is a schematic illustration of a system to align panelist data with retailer sales data in accordance with the teachings of this disclosure.

FIG. 2 is a schematic illustration of an example period weighting engine of FIG. 1.

FIG. 3 is a table of example elementary periods used by a period counter in the system of FIG. 1.

FIG. 4 is a schematic illustration of an example trip calibration engine of FIG. 1.

FIG. 5 is a schematic illustration of an example trip aggregation engine of FIG. 1.

FIGS. 6-9 are flowcharts representative of example machine readable instructions which may be executed to align panelist data with retailer sales data.

FIG. 10 is a schematic illustration of an example processor platform that may execute the instructions of FIGS. 7-10 to implement the example systems and apparatus of FIGS. 1-6.

### DETAILED DESCRIPTION

Market researchers invest substantial amounts of money and resources to recruit and maintain consumer panelists. Such consumer panelists facilitate predictions of one or more purchasing behaviors, which may be performed more accurately when panelist members comply with one or more reporting procedures. Samples of consumers are drawn that meet one or more demographic parameters of interest (e.g., particular ethnicity, particular economic disposition, particular age, etc.), in which the samples of consumers are willing to participate in reporting procedures, such as scanning purchased products with bar-code scanners and/or journal/diary entry requirements. From the participating panelists, behavior projections are usually made to reflect a larger portion of a population, such as a regional or national projection.

Each household may be associated with a weight based on members of the household panel, which may be influenced by a particular geography, an income and/or any other demographic parameter. Panelist recruitment, vetting and maintenance typically requires substantial financial investments, thus the number of panelist members associated with each demographic profile of interest may be relatively low. As such, the corresponding weighting value(s) for each household may be relatively high, and such high weighting values may result in substantial projection error when panelist reporting is non-compliant.

To combat errors that may result from non-compliance, one or more pickup drivers (weights) may be associated with the households to correct for bias. For example, households with relatively older panelists without children tend to comply with reporting procedures better than relatively younger panelists with children. Household pickup drivers associated with the relatively younger panelists with children may inflate and/or otherwise boost reporting information provided by such panelists under the expectation that families with children may be more distracted with childcare. When reporting procedures expected from the panelists compete with family related obligations of childcare, the pickup drivers compensate for heuristic effects of underreporting by the relatively younger panelists with children. In other words, in the event a household associated with relatively younger panelists with children reports a purchase of a single jar of baby formula, one or more pickup drivers inflate the reporting information to match a likely scenario that the panelists actually purchased much more baby formula than what was reported, but failed to comply with proper reporting procedures due to distraction/busyness, etc.

Another approach to obtaining information indicative of market activity includes cultivation and analysis of retail sales data. Retail sales data is typically acquired at the point-of-sale via one or more bar-code scanning devices (e.g., universal product code (UPC) bar-code scanning devices at retailer checkout lanes). Unlike panelist reporting compliance, retail sales data is deemed an accurate reflection of volumetric market activity, such as a total number of UPCs sold at a particular retail establishment, group of retail establishments, and/or other collective geographic area. While the retail sales data may indicate volumetric sales trends, such data does not include corresponding demographic information related to the types of consumers responsible for the trends. In other words, the panelist data is highly valuable to identify who is making purchases, who is not making purchases, how often one or more purchases are made, and/or whether there has been a change in behavior, etc. As such, both panelist data and retail sales data maintain value when undertaking one or more marketing studies and/or initiatives.

However, in some instances the panelist data fails to align with retail sales data. Retail sales data may indicate growth for a particular brand, category and/or product, while panelist data may indicate negative trends associated with households. For example, in the event retail sales data indicates a market increase of 10%, but panelist data indicates a number of buyers has decreased by 3%, a purchase frequency has decreased from 1.4% to 1.2%, and/or a value per occasion decreased from $10 to $8, then such circumstances illustrate an inconsistency between retail sales data and panelist data. In some examples, market researchers and/or clients assume that the panel data fails to reflect a true indication of market activity. Such trend misalignment may be a source of frustration for clients and may reveal that panelist data lacks a degree of accuracy expected by market researchers. While cultivated retail sales data reflects most or all retail purchases via in-store barcode scanning devices, it is considered more reliable than panelist data that can be negatively affected by non-compliant panelists that fail/forget to scan purchases at home (e.g., Homescan® panelists). Compared to retail sales data, the panelist data is much more sparse, granular and volatile. As such, the panelist data reflects a greater degree of variability that can lead market researchers and/or other clients to question the value of both retail sales data and panelist purchasing/behavior data.

Projections based on retrieved panelist information are typically constructed around a household as a basic unit of sampling. In that regard, some behavioral details throughout a reporting period (e.g., a reporting period of one month) are lost when applying weighting values at a household level. At least one source of misalignment (e.g., increased variance between retail sales data and panelist data) is that household level analysis applies a weight to accumulated household behavior in view of the pickup drivers and/or known channel structures. While any number of individual shopping trips by one or more of the household members occur during the reporting period (e.g., one month), a single household weight is associated with all of the shopping trips made by the household when employing the traditional techniques of marketing projection. For example, some categories may have panelist reporting compliance at a relatively high value (e.g., 95%), while other categories may experience substantially lower panelist reporting compliance levels (e.g., 50%). The household weight is based on one or more heuristics in an attempt to optimize expectations for total market population and demographic targets associated with a particular household make-up, and does not account for differences across the one or more shopping trips made by the household. Additionally, in the event a trip by a household member purchased from categories that both have the relatively high reporting compliance and the relatively low reporting compliance, the single household weight would be applied to each of these categories in the same manner.

Applying such a common household weight/calibration factor in both category purchase occasions fails to reveal a degree of accuracy indicative of actual market activity. Sole reliance upon household weights (sometimes referred to herein as “household factors,” or “household expansion factors”) is also flawed in view of changing markets and/or changing household characteristics. Traditional reliance upon a first household having, for example, two adults and one child could carry a degree of behavioral market expectations for a second household having the same configuration. However, such stereotypical reliance no longer results in repeatable observations to the degree it once did, and shopping behaviors reveal divergent baskets despite similarities in household configurations.

Example methods, apparatus and/or articles of manufacture disclosed herein reduce a disparity between consumer panel service (CPS) data (e.g., cultivated panelist data) and retail measurement services (RMS) data. Improving alignment between the CPS data and the RMS data includes, in part, period weighting cultivated CPS data to reduce the effects of attrition and waste, calibrating volumes associated with CPS data at a level of individual shopping trips to reach a consistency with RMS data by adjusting initial weights and aligning period-weighted consumer data in a manner that is consistent with the calibrated CPS volumes. Example methods, apparatus, systems and/or articles of manufacture disclosed herein apply a level of a trip instead of sole reliance on the household level analysis. As such, each category in a basket includes a corresponding trip weight (sometimes referred to herein as “trip factors,” or “trip expansion factors”) to increase a degree of precision in view of one or more varying categories that result from household shopping activity.

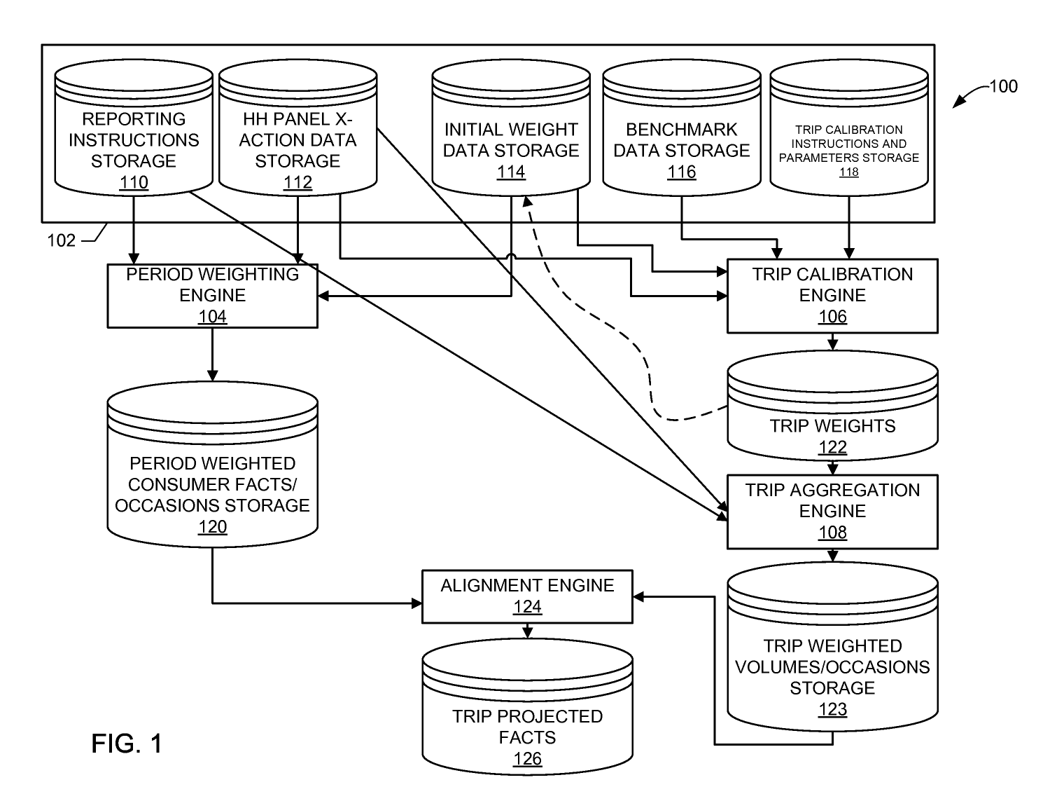

FIG. 1 is a schematic illustration of a system 100 to align panelist data with retailer sales data. In the illustrated example of FIG. 1, the system 100 includes a system data source 102 having one or more inputs communicatively connected to a period weighting engine 104, a trip calibration engine 106, and a trip aggregation engine 108. The example inputs of the system data source 102 include a reporting instructions storage 110, a household panel transaction data storage 112, an initial weight data storage 114, a benchmark data storage 116, and a trip calibration instructions and parameters storage 118. As described in further detail below, the example period weighting engine 104 facilitates the ability to roll-up elementary periods of panelist data into relatively longer reporting timeframes in a manner that retains panelist data that would otherwise be wasted due to non-compliance.

The example reporting instructions storage 110 includes information related to a marketing initiative focus. In the illustrated example of FIG. 1, the reporting instructions storage 110 includes information indicative of a period of interest, a market of interest, demographics of interest, and/or one or more product(s) of interest. In some examples, a particular market of interest includes corresponding relevant retailers, while in other examples a particular demographic of interest includes corresponding relevant geographic identifiers, products and/or age groups. The example reporting instructions storage 110 also includes facts of interest that may be targeted as deliverables of one or more marketing initiatives. Facts may include, but are not limited to purchase values, penetration values or repeat rates of purchase.

The example household panel transaction data storage 112 includes panelist data that originates from any type of panelist data collection system including, but not limited to, Homescan® panelists. In some examples, Homescan® panelists are demographically selected to report purchases made via in-home universal product code (UPC) scanning devices. The example household panel transaction data storage 112 includes household identifier information, dates and/or times of panelist activity, store information associated with panelist purchase activity, UPC, quantities of product units purchased and corresponding unit price information, and/or demographic details associated with the panelists (e.g., age, head of household, income, ethnicity, etc.).

The example initial weight data storage 114 includes starting point weighting values for calibration. A collection of household weights (sometimes referred to herein as “household projection factors”) may be stored in the example initial weight data storage 114 for the example period weighting engine 104, and such household weights may also be provided to the example trip calibration engine 106 to associate trip behaviors with corresponding household characteristics. As described further below, one or more initial weights may be adjusted based on marketing initiative approaches, in which initial weights may be maintained at an expense of accuracy, initial weights may be adjusted in favor of accuracy, or any combination thereof. In some examples, and as described in further detail below, one or more initial weights may be updated in a recursive manner to accommodate reports and/or deliverables related to categories and/or multi-category analysis.

The example benchmark data storage 116 includes data associated with retailer collection efforts. Generally speaking, retailer collected data may carry a degree of reliability deemed superior to that exhibited by panelist data because, in part, retailer collection efforts typically do not suffer effects associated with human compliance issues. The example benchmark data storage 116 may include scanner data from on-site point-of-sale (POS) checkout scanners, purchasing data associated with consumer loyalty cards and/or manufacturer shipment data.

The example trip calibration instructions and parameters storage 118 includes data associated with calibration targets. In some examples, calibration targets include the combination of retailers, period(s) and products (merchandise) related to client requirements. The calibration targets may also include coverage rates (e.g., values) for such combinations of retailers, period(s) and merchandise.

Example methods, apparatus, systems and/or articles of manufacture disclosed herein bridge the gap between actual CPS reporting (e.g., 30% reported) and the trip targets (e.g., 55% expected to be reported). In addition to the trip targets stored by the example trip calibration instructions and parameters storage 118, household projection factors from the example initial weight data storage 114 are inherited by and/or otherwise applied to every individual trip that may occur in a basket. Thus, in circumstances where a first category is relatively far away from a current CPS reporting metric (e.g., CPS data is only at 50% while the category target is 80%), and a second category is relatively close to its target (e.g., CPS data is at 90% while the category target is 95%), application of trip-based weights per category rather than grossly applied household weights facilitate the ability to improve on a requisite degree of accuracy when correcting the CPS data to be aligned with RMS data. As described above, employing a level of the trip (trip projection factors) instead of sole reliance on household level weights enable precise category correction in view of shopping baskets having a disparate category assortment.

Additionally, the example trip calibration instructions and parameters storage 118 includes parameters to tailor trip weights from their initial positions. As described above, starting point weights may be adjusted in a relatively conservative manner (e.g., do not deviate the initial weights beyond a threshold), or the starting point weights may be adjusted in a relatively liberal manner (e.g., allow initial weight deviation beyond a threshold). The example parameter values tailor a balance between such extremes.

Generally speaking, panelist households are expected to comply with reporting procedures for an overall reporting period. Each overall reporting period may contain any number of periodic reporting instances, such as 52 weekly reporting instances throughout the course of a year-long overall reporting period, 13 four-week reporting instances throughout the course of a year-long overall reporting period, etc. In the event a panelist household begins complying with reporting procedures after a marketing initiative begins (e.g., a relatively new panelist household that starts reporting procedures 3-months after a marketing initiative), then traditional criteria for maintaining panelist reporting data may reject that relatively new panelist household as a source for panelist data because it was non-compliant throughout the entire 13 four-week overall reporting period. In another example, if a panelist household misses one or more of the periodic reporting instances (e.g., five of the thirteen four-week reporting periods), all corresponding panelist data from the offending household is typically discarded for reasons of non-compliance. Such data discards are typical despite any prior history of the household maintaining a satisfactory compliance record (e.g., compliant for 10-months prior to one instance of non-compliance).

In view of the possibility of household panelist data being discarded for reasons of non-compliance, the example period weighting engine 104 identifies elementary periods of household data that complies with one or more reporting procedure criteria and retains such elementary periods for marketing initiatives. In the event one or more elementary periods of household data do not comply, then the example period weighting engine discards only such portions of panelist data affected by the non-compliant behaviors, while preserving viable portions. In some examples, only those households that are deemed “useable” are stored in the example household panel transaction data storage 112. Additionally, the example period weighting engine 104 provides an estimate of penetration that is in sync with volumetric estimates, as described in further detail below. While the non-period weighted CPS data will include a degree of reporting associated with a period lower than that for the reporting period (which boils down to a completely/perfectly compliant measurement, but at a shorter period length), the example period weighting engine 104 generates a new consumer-based fact (e.g., penetration purchase frequency) that is completely compliant for the true reporting period.

As also described in further detail below, the example trip calibration engine 106 facilitates trend improvement accuracy of CPS data by aligning the CPS data relative to RMS data. Generally speaking, the example trip calibration engine 106 builds volumetric facts (e.g., occasions, volumes, values) that are driven by attributes related to shopping trips. As described above, unlike household level data, such as traditional CPS data, trip-level data includes a relatively greater degree of granularity that is used to develop corrections for the alignment of CPS data. Results from the example trip calibration engine 106 are stored in an example trip weight storage 122 and include results from calibration(s) such that final trip weights may be optimized. For example, final trip weights may include a corresponding distance to one or more targets that is minimized in view of raw transaction data and aggregated along a calibration frame. The example calibration frame may relate to combination(s) of a market, a product, and one or more period combinations. The trip factors (trip weights) generated by the example trip calibration engine 106 are based on one or more calibration targets, trip purchase values and parameters, such as budget parameters, as described in further detail below.

The example trip aggregation engine 108 uses the final trip weights from the example trip weight storage 122, reporting instructions and raw data from the example household panel transaction data storage 112 to calculate projected contributions based on the weights and qualifying panelist data. The example trip aggregation engine 108 sums the contributions of the volumetric data and stores the output in the example trip weighted volumes and occasions store 123, as described in further detail below.

Volumetric information from RMS data is useful to identify one or more trends in sales for particular products and/or categories of products. Additionally, CPS data may also be useful to the market researcher to identify underlying diagnostics that represent such volumetric activity, such as the types of consumers responsible for one or more identified trends. However, because data generated by the example period weighting engine 104, the example trip calibration engine 106 and the example trip aggregation engine 108 have different levels of granularity (i.e., household level data versus trip level data, respectively), an example alignment engine 124 applies a negative binomial distribution to minimize a trend gap between the CPS and RMS data. Results from the example alignment engine 124 are stored in an example trip projected fact storage 126.

In operation, the example period weighting engine 104 retrieves panelist data (e.g., CPS data) from the example household panel transaction data storage 112 based on example instructions and/or marketing initiatives from the example reporting instructions storage 110 for a report period of interest. For example, a market researcher may wish to analyze marketing activity for a twelve (12) month period for the purpose of generating projections. As described above, the CPS data may be useful to the market researcher to identify underlying diagnostics that represent volumetric activity, such as the types of consumers responsible for one or more identified trends. One or more portions of the CPS data is identified by the example period weighting engine 104 that is suitable for a reporting period of interest or, in other examples, only households that satisfy one or more criteria for usability are stored in the example household panel transaction data storage 112. Previous approaches to discriminating which raw data to maintain from panelist data sources for marketing research focused on statics, which is a particular time period reported by a market researcher. Typically, only panelists exhibiting the highest compliance to reporting guidelines are part of a final selection of households from which transaction data is used. At least one problem with this approach is that the panel of data suffers from attrition when removing relatively substantial portions of viable panelist data. In such approaches, valuable data is discarded from consideration for statistical projections because a relatively small portion of that data failed to exhibit satisfactory quality metrics.

To avoid waste of viable panelist data, example methods, apparatus and/or articles of manufacture disclosed herein employ period weighting. The example period weighting engine 104 of FIG. 1 identifies the reporting period of interest (e.g., thirteen 4-week periods) and establishes an elementary portion (e.g., 4-weeks) of the reporting period. As described in further detail below, rather than discard household panelist data if a corresponding full reporting period (e.g., all thirteen of the 4-week periods) fails to comply with quality metrics, each household panelist data set that satisfies such quality metrics for the elementary period (e.g., a 4-week period) may be retained for analysis purposes. Elementary periods from one or more combinations of any number of panelist households or other panelist data sets may be combined as needed for each of the elementary periods that make-up the reporting period. For example, a market researcher overall reporting period of 52-weeks may be further divided into thirteen separate four-week elementary periods. For each panelist household and/or other candidate panelist data set, if acceptable quality metrics are satisfied for an elementary period, then that subset of panelist data (having one or more instances of panelist behavior, such as shopping data) may be used for market research projections. As such, in the event a household only satisfies quality data metrics for ten out of the thirteen periods, then a major portion of viable data is retained for statistical purposes rather than discarding otherwise good data. Additionally, because the period weighting retains a greater number of panelists than the traditional static, the applied projection weights will exhibit better stability as the impact of attrition is reduced and/or otherwise minimized.

The example retained panelist data generated by the example period weighting engine 104 is further used to generate one or more projections using the corresponding households as sampling units. As described above, a degree of granularity may be lost using such industry standard projection approaches.

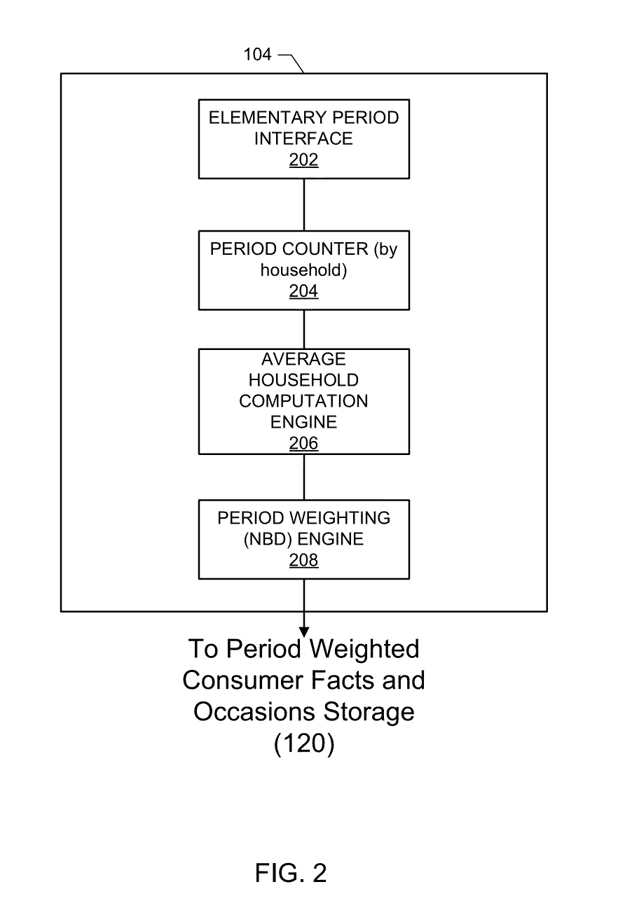

FIG. 2 is a block diagram of the example period weighting engine 104 of FIG. 1. In the illustrated example of FIG. 2, the period weighting engine 104 includes an example elementary period interface 202, an example period counter (by household) 204, an example average household factor computation engine 206 and an example period weighting negative binomial distribution (NBD) engine 208 communicatively connected to the example period weighted consumer storage 120 of FIG. 1. In operation, the example elementary period interface 202 identifies elementary periods that overlap with the reporting period. Additionally, the example elementary period interface 202 identifies households that satisfy useable criteria, as indicated by the example initial weight data storage 114. The example period counter 204 associates each household with a number of useable elementary periods within the reporting period, and the example average household factor computation engine 206 calculates an average household projection factor over the reporting period for each household. The example period weighting NBD engine 208 calculates an average period length based on the household expansion factors, and applies the true (e.g., full 13 periods) and the average period length to a number of occasions. For example, if the average period length is 11.82, the full period length is 13 (as determined by the market study roadmap), then the period weighting NBD engine 208 will adjust the non-period weighted consumer facts towards a set of facts corresponding to the full reporting period length (number of households/penetration, number of occasions, number of occasions per buyer/purchase frequency, etc.).

Stated differently, the example period weighting engine 104 facilitates moving away from an approach where households are required to regularly contribute to an overall time period. Instead, each household may contribute to any portion of the whole that meets one or more useability criteria. Weights associated with households are assigned by the example period weighting engine 104 in a manner consistent with a degree of participation (award). For example, the weight awarded to a household that complied with two of thirteen periods is associated with a weight that is substantially lower than a household that complied with ten or more periods. The weighting values may be applied in any manner such as, for example, a simple ratio of complied periods to total periods (e.g., a ratio), or based on a non-linear model (e.g., a plotted curve).

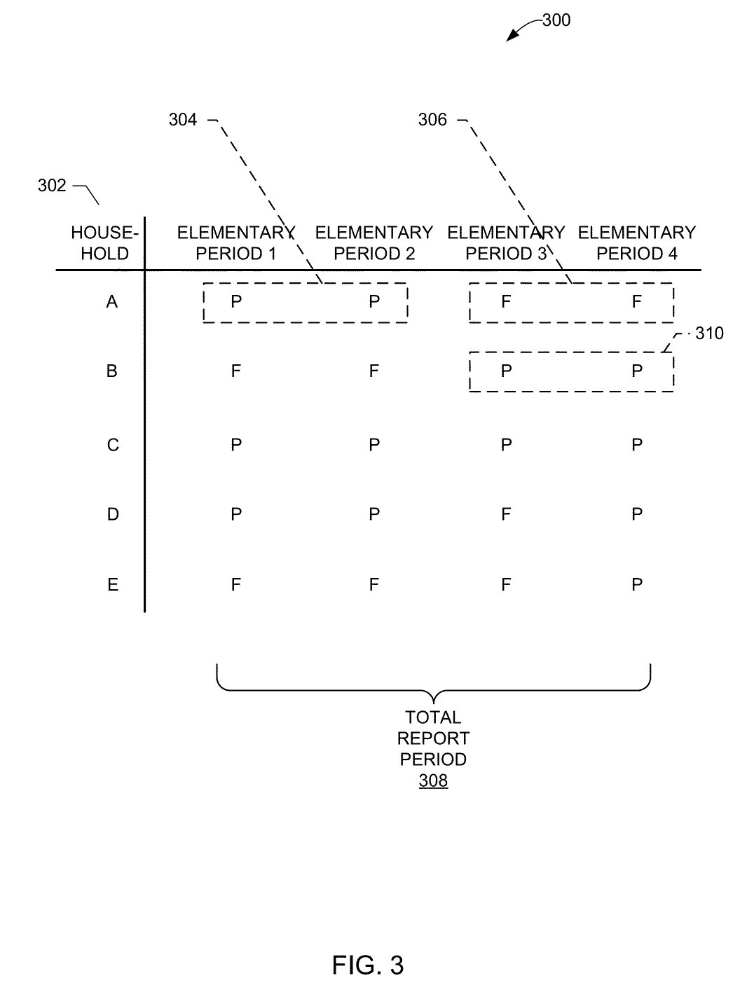

As described above, each example elementary period from each household may be assigned a corresponding weight based on, in part, a number of time periods in which compliant reporting behaviors occurred. Additionally or alternatively, each household may be assigned an aggregate weight based on a number of compliant elementary periods occurring, as described in further detail below. FIG. 3 illustrates a table 300 of example households having corresponding elementary periods. In the illustrated example of FIG. 3, the table 300 includes a household column 302 to reflect five example households named “A” through “E.” Each household has an associated elementary period column, named with numbers “1” through “4.” While the illustrated example table 300 of FIG. 3 only includes five example households having four corresponding elementary periods, example methods, apparatus and/or articles of manufacture disclosed herein are not limited thereto. In the event a household satisfies and/or otherwise complies with panelist reporting periods, the example table 300 includes a pass designator “P.” On the other hand, in the event a household fails to satisfy and/or otherwise comply with panelist reporting periods for a given elementary period, the example table 300 includes a fail designator “F.”

In the illustrated example of FIG. 3, the table 300 reflects that household “A” satisfied reporting obligations for a first of two (out of four) elementary reporting periods 304 (elementary periods “1” and “2”), but failed to satisfy reporting obligations for the last two elementary reporting periods 306 (elementary periods “3” and “4”) for a total reporting period 308. While any elementary reporting period for a corresponding household may be used when generating projections, such households having greater numbers of elementary periods are assigned a relatively higher influence than households having fewer instances of periods of compliance.

For example, assuming that all households would start from the same household projection factor, household “C” may be associated with the highest influence because it has complied with all four elementary periods, while household “E” will receive the relatively lowest influence for only satisfying one elementary period. Weighting values assigned and/or otherwise associated with households “A” and “B” may be set at equal levels because they both exhibit a quantity of two elementary periods of compliant reporting behavior.

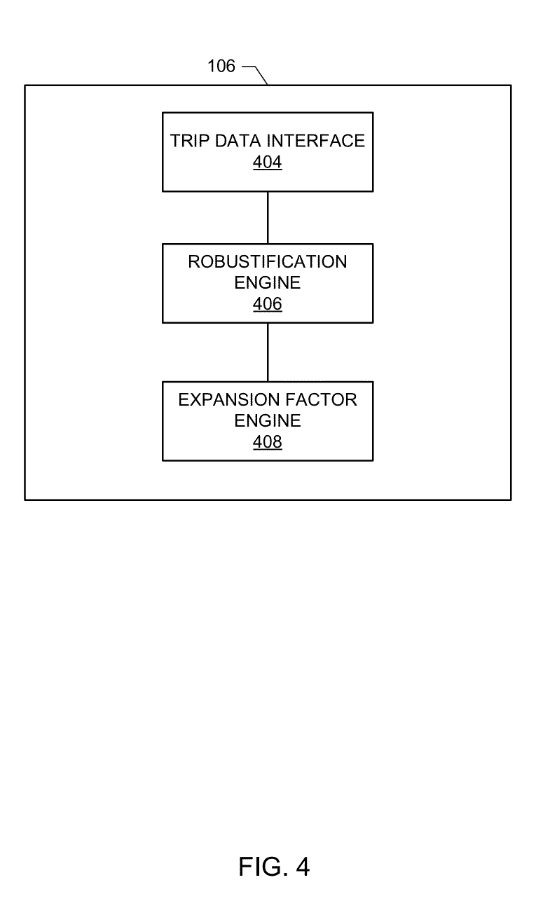

Unlike the example period weighting engine 104 of FIG. 1, the example trip calibration engine 106 generates trip projection factors using trips as the sampling unit. FIG. 4 illustrates a block diagram of the example trip calibration engine 106. In the illustrated example of FIG. 4, the trip calibration engine 106 includes an example trip data interface 404, an example robustification engine 406, and an example expansion factor engine 408. In operation, the example trip data interface 404 retrieves calibration targets from the example trip calibration instructions and parameters storage 118, and retrieves CPS raw data from the example household panel transaction data storage 112. The example expansion factor engine 408 associates CPS raw data trips with corresponding initial trip expansion factors from the initial weight data storage 114, and the example trip data interface 404 retrieves overall parameters. As described above, the overall parameters may include the budget parameters in which relatively lower values allow closer tracking to initial positions, while relatively larger values allow tracking closer to the calibration targets.

The example robustification engine 406 applies target robustification that allows targets to approach in a manner consistent with the budget parameter and the intrinsic variability associated with the number of observations. Generally speaking, the fewer observations that are available result in a relatively higher degree of variability of estimates, which reflects a higher tolerance. The variability is proportional in a manner consistent with example Equation 1.

$$Variability ∝ \frac{1}{\sqrt{Number of Observations}} . \qquad Equation 1$$

In the illustrated example of Equation 1, in the event the error is to be diminished by half, then a quantity of four times the observations will be needed.

The example trip calibration engine 106 calculates a set of trip factors based on the calibration targets, each trip purchase value and the budget parameter. Additionally, the example trip calibration engine 106 may feed the trip weights back to the example initial weight data storage in some instances where recursive weights are to be generated in connection with multi-category analysis.

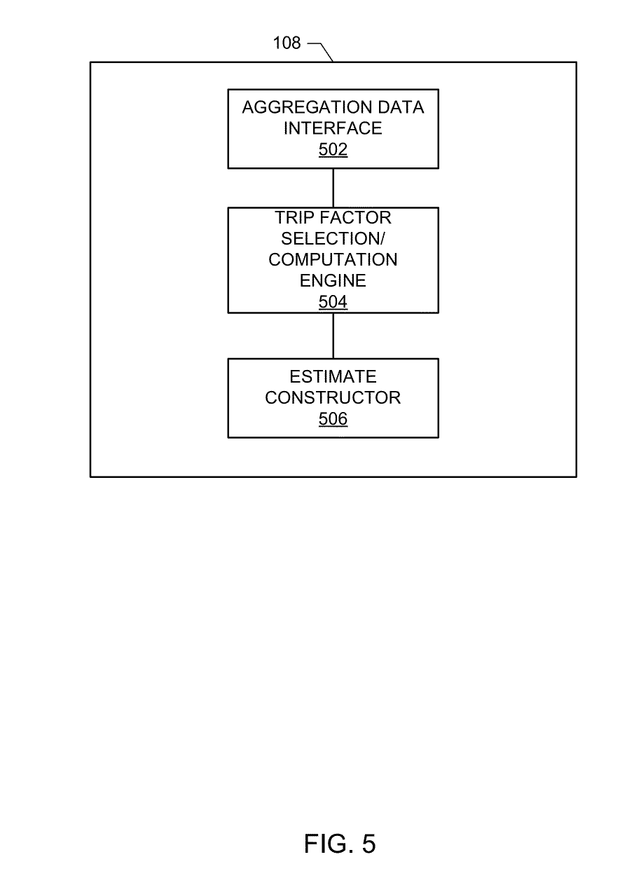

FIG. 5 illustrates further detail of the example trip aggregation engine 108 of FIG. 1. In the illustrated example of FIG. 5, the trip aggregation engine 108 includes an aggregation data interface 502, a trip factor selection/computation engine 504, and an estimate constructor 506. In operation, the example aggregation data interface 502 retrieves trip weights from the trip weights 122, and retrieves roadmap information from the example reporting instructions storage 110. For example, the roadmap information may include a period of interest, market of interest, category of interest, product of interest and household type(s). The example calibration fit engine 118 identifies which data best fits the client instructions and/or objectives. Such indications of appropriate data may be stored in the example trip calibration instructions and parameters storage 118.

A deliverable strategy may also be identified by the example reporting instructions storage, which tailors aggregation efforts to relative categories and/or products. Some strategies may focus on a single product, others may focus on a multi-category analysis, while still other example strategies may employ an average of category products. For example, a multi-category of hair care products may be identified by a market researcher to include shampoo, conditioner, styling gels and hair sprays. On the other hand, the multi-category of hair care products may be defined by a client to omit hair sprays from that multi-category definition. Further, the client may know that the multi-category is truly dominated by one of the specific products to a much higher degree than others, thereby allowing a greater degree of focus on market activity relevant to the client. The example estimate constructor 506 constructs an estimate based on the client directives in the example reporting instructions storage 110, and sums relevant contributions of the volumetric data.

Stated differently, the example trip aggregation engine 108 pulls together any number of trip factors for each trip. Any trip may have one or more trip factors based on multi-category behaviors and/or factors that focus on one particular product as a basis for weighting. For example, the marketing initiative may have a focus on hair care products in which shampoo and conditioner are included. Based on the instructions retrieved from the example trip calibration instructions and parameters storage 118, one or more trip factors may be evaluated as a basis for a trip weight. In the example of shampoo and conditioner, trip factors can consider the combination of shampoo plus conditioner, shampoo alone (e.g., regardless of conditioner), and conditioner alone (e.g., regardless of shampoo). In the event the marketing initiative focus is only for shampoo, then the corresponding trip weight will be that of shampoo only. On the other hand, in the event the marketing initiative focus is only for conditioner, then the corresponding trip weight will be that of conditioner only. In the event the marketing initiative focus is on both categories of shampoo and conditioner, then a weighted average is computed.

The example trip aggregation engine 108 computes a weighted average in connection with individual trip weights for each product (e.g., a shampoo trip weight, a conditioner trip weight) and a corresponding raw purchase value. For example, if shampoo has a trip weight of 1000 and a corresponding purchase value of $10, and conditioner has a trip weight of 500 and a corresponding purchase value of $5, then a final trip weight (FTw) may be calculated in a manner consistent with example Equation 2.

$$FTw = \frac{( 1000 * 10 + 500 * 5 )}{( 10 + 5 )} = 833.33 . \qquad Equation 2$$

Continuing with the example above, a corresponding weighted trip value for shampoo (S_{TW}) may be calculated in a manner consistent with example Equation 3, and a corresponding weighted trip value for conditioner (C_{TW}) may be calculated in a manner consistent with example Equation 4.

S_{TW}=($10)*833.33=$6333.30 Equation 3.

C_{TW}=($5)*833.33=$4166.67 Equation 4.

Results are then stored in the example trip weighted volumes and occasions storage 123.

In view of the trip-level facts stored in the example trip weighted volumes and occasions storage 123 and the household-level facts stored in the example period weighted consumer storage 120, an inconsistency exists. The inconsistency relates to the fact that period weighted adjustments and trip calibration adjustments have been made independently and serve different purposes (e.g., alignment to RMS versus reducing waste in raw data in removal of common samples). This inconsistency does not permit a volume calculation, as shown in example Equation 5.

Vol=(# of buyers)*(purchase freq.)*(vol.per occasion) Equation 5.

In the illustrated example of Equation 5, vol reflects a volume which may be aligned with, for example, RMS data. The number of buyers (# of buyers) in the illustrated example of Equation 5 is also referred to as the penetration, and the penetration and purchase frequency (purchase freq.) are both based on household factors related to CPS data. On the other hand, the volume per occasion (vol. per occasion) in the illustrated example of Equation 4 is based on volumetric facts at a trip level and, potentially, related to RMS data. In other words, example Equation 5 is misaligned (i.e., trip-level resolution vs. household-level resolution).

The example alignment engine 124 acts upon the two measures of the number of projected occasions based on the projection weights (from the household and the trips). The gap in coverage that resides between these two measures is bridged and/or otherwise converged-upon via application of a Negative Binomial Distribution (NBD) model to minimize the gap between the household-level projections and the trip-level projections.

The example alignment engine 124 retrieves and/or otherwise receives the aggregated volumetric facts (e.g. volume, value, . . . ) from the example trip weighted volume storage 123 and retrieves and/or otherwise receives the aggregated household facts (e.g. penetration, purchase frequency, . . . ) from the example period weighted consumer storage 120. Application of the NBD model by the example alignment engine 124 generates one or more adjustments based on the differences between the household volumetrics and the trip-level volumetrics to be used as a correction factor for panelist-based data, thereby allowing a proper volume decomposition into consumer metrics as per the calculation of example Equation 5 and reducing alignment disparity between the CPS and RMS data.

While an example manner of implementing the system 100 to align panelist data with retailer sales data has been illustrated in FIGS. 1-5, one or more of the elements, processes and/or devices illustrated in FIGS. 1-5 may be combined, divided, re-arranged, omitted, eliminated and/or implemented in other ways. Further, the example system data source 102, the example period weighting engine 104, the example trip calibration engine 106, the example trip aggregation engine 108, the example reporting instructions storage 110, the example household panel transaction data storage 112, the example initial weight data storage 114, the example benchmark data storage 116, the example trip calibration instructions and parameters storage 118, the example period weighted consumer facts and occasions storage 120, the example trip weighted volume volumes and occasions storage 123, the example alignment engine 124, the example trip projected facts storage 126, the example elementary period interface 202, the example period counter 204, the example average household factor computation engine 206, the example period weighting NBD engine 208, the example trip data interface 404, the example expansion factor engine 408, the example robustification engine 406, the example aggregation data interface 502, the example trip factor selection/computation engine 504 and/or the example estimate constructor 506 of FIGS. 1-5 may be implemented by hardware, software, firmware and/or any combination of hardware, software and/or firmware. Thus, for example, any of the example system data source 102, the example period weighting engine 104, the example trip calibration engine 106, the example trip aggregation engine 108, the example reporting instructions storage 110, the example household panel transaction data storage 112, the example initial weight data storage 114, the example benchmark data storage 116, the example trip calibration instructions and parameters storage 118, the example period weighted consumer facts and occasions storage 120, the example trip weighted volume volumes and occasions storage 123, the example alignment engine 124, the example trip projected facts storage 126, the example elementary period interface 202, the example period counter 204, the example average household factor computation engine 206, the example period weighting NBD engine 208, the example trip data interface 404, the example expansion factor engine 408, the example robustification engine 406, the example aggregation data interface 502, the example trip factor selection/computation engine 504 and/or the example estimate constructor 506 of FIGS. 1-5 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example system data source 102, the example period weighting engine 104, the example trip calibration engine 106, the example trip aggregation engine 108, the example reporting instructions storage 110, the example household panel transaction data storage 112, the example initial weight data storage 114, the example benchmark data storage 116, the example trip calibration instructions and parameters storage 118, the example period weighted consumer facts and occasions storage 120, the example trip weighted volume volumes and occasions storage 123, the example alignment engine 124, the example trip projected facts storage 126, the example elementary period interface 202, the example period counter 204, the example average household factor computation engine 206, the example period weighting NBD engine 208, the example trip data interface 404, the example expansion factor engine 408, the example robustification engine 406, the example aggregation data interface 502, the example trip factor selection/computation engine 504 and/or the example estimate constructor 506 of FIGS. 1-5 is hereby expressly defined to include a tangible computer readable storage medium such as a memory, DVD, CD, Blu-ray, etc. storing the software and/or firmware. Further still, the example system 100 of FIG. 1 may include one or more elements, processes and/or devices in addition to, or instead of, those illustrated in FIG. 1 and/or may include more than one of any or all of the illustrated elements, processes and devices.

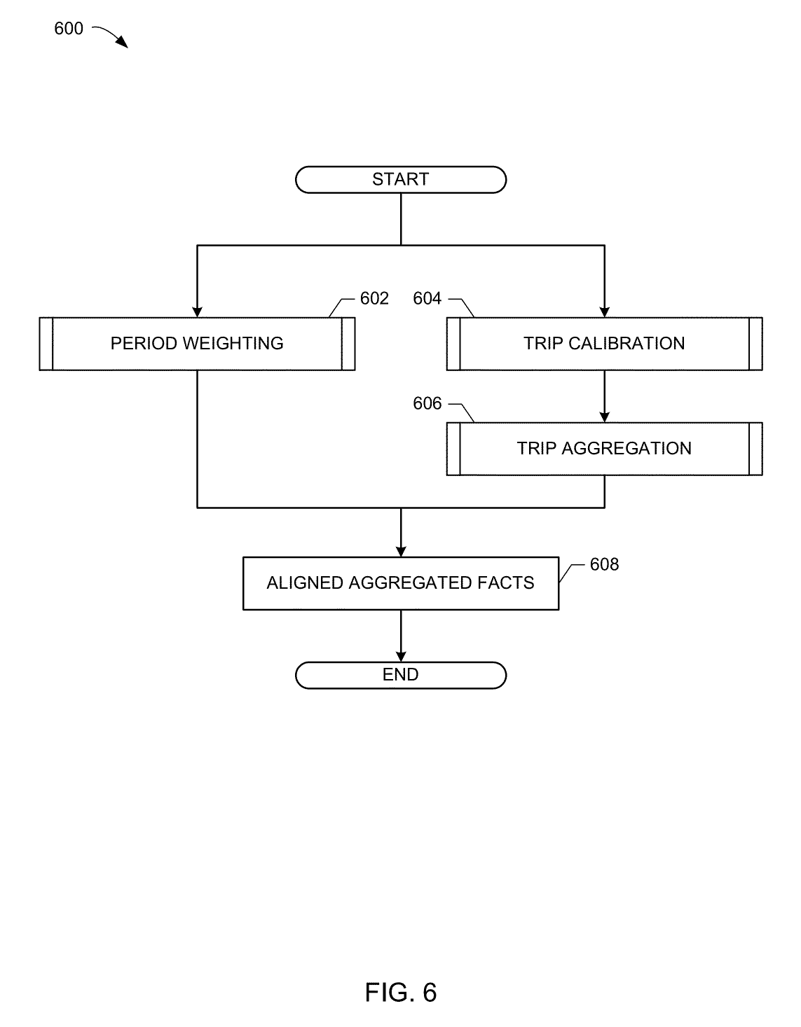

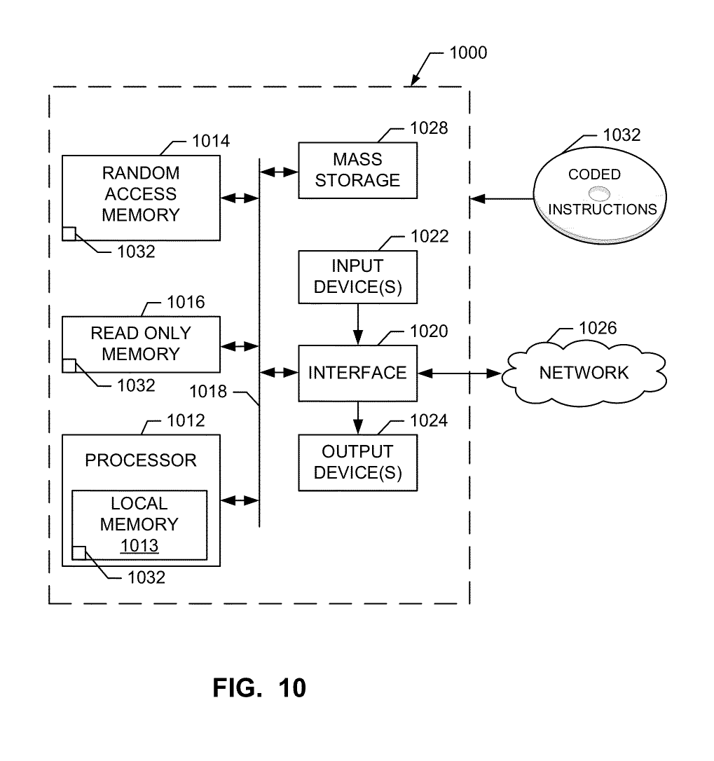

Flowcharts representative of example machine readable instructions for implementing the system 100 of FIG. 1 are shown in FIGS. 6-9. In these examples, the machine readable instructions comprise a program for execution by a processor such as the processor 1012 shown in the example computer 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 6-9, many other methods of implementing the example system 100 to align panelist data with retailer sales data may alternatively be used. For example, the order of execution of the blocks may be changed, and/or some of the blocks described may be changed, eliminated, or combined.

As mentioned above, the example processes of FIGS. 6-9 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 6-9 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 600 of FIG. 6 begins at block 602 or at block 604 in a manner initially independent of each other. While the illustrated example of FIG. 6 begins discussion in connection with block 602, example methods, apparatus, systems and/or articles of manufacture disclosed herein are not limited thereto. The example period weighting engine 104 retains CPS data that would otherwise be wasted with traditional panelist data retention methods (block 602). The example trip calibration engine 106 overcomes limitations related to a lack of granularity with respect to household level category analysis by employing trip projection factors (block 604), and the example trip aggregation engine 108 generates a sum of contributions of volumetric data based on trip weights and qualifying panelist data (block 606). Because of inconsistencies between the trip-level facts from the example trip calibration engine 106 and household-level facts from the example period weighting engine 104, the example alignment engine 124 reduces, minimizes and/or otherwise eliminates the gap in coverage that resides between these two measures via application of a negative binomial distribution (block 608).

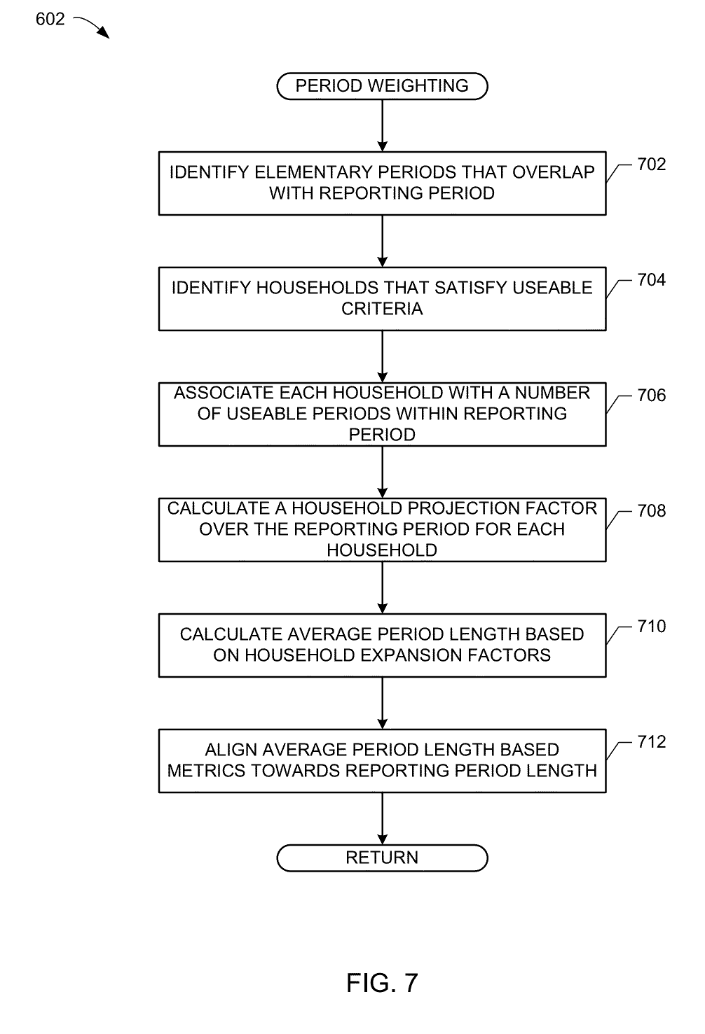

FIG. 7 illustrates block 602 from FIG. 6 in greater detail. In the illustrated example of FIG. 7, the example elementary period interface 202 identifies elementary periods that overlap with the reporting period of interest (block 702). Additionally, the example elementary period interface 202 identifies households that satisfy useable criteria (block 704). The example period counter 204 associates each household with a number of useable elementary periods within the reporting period (block 706). The household projection factor is calculated by the example average household factor computation engine 206 over the reporting period for each household (block 708), which could be based on a ratio, a non-linear model and/or any other manner of proportionate weighting, as described above. The example period weighting NBD engine 208 calculates an average period length based on the household expansion factors (block 710), and aligns the average period length based metrics towards reporting period length (block 712). As described above, the number of occasions may be split into a penetration value and a number of baskets per household.

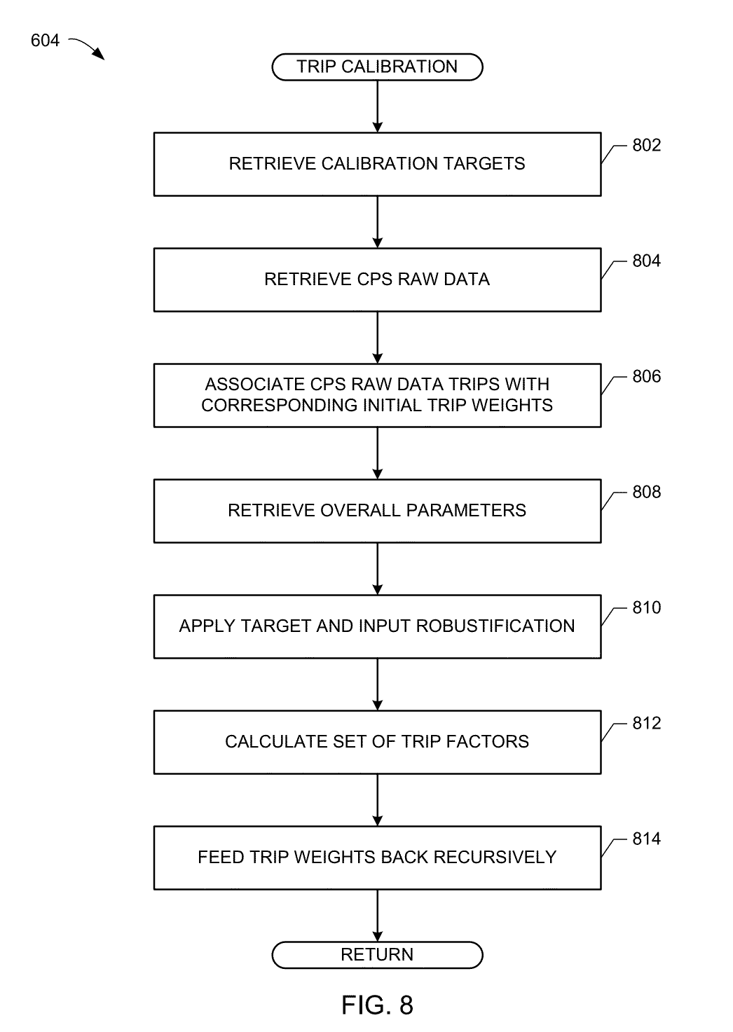

FIG. 8 illustrates block 604 from FIG. 6 in greater detail. In the illustrated example of FIG. 8, the example trip data interface 404 retrieves calibration targets from the trip calibration instructions and parameters storage 118 (block 802), and retrieves CPS raw data from the household panel transaction data storage 112 (block 804). The example expansion factor engine 408 associates CPS raw data trips with corresponding initial trip weights (block 806). The example household expansion factors reflect a function of the type of household that participated in the trip, and the manner in which a trip is defined is a combination of a household in an outlet on a given day. Additionally, the expansion factor engine 408 considers the trip purchase value(s) in any given trip.

The example trip data interface 404 retrieves overall parameters (block 808). As described above, the parameters may include a budget parameter to control a degree to which calibration targets are tracked. The example robustification engine 406 applies target and input robustification (block 810), and the trip calibration engine 106 calculates a set of trip factors (block 812). The trip factors calculated by the example trip calibration engine 106 are based on the calibration targets, the trip purchase value and the budget parameters. The trip factors are not determined and/or otherwise calculated individually, but are determined as a set. The trip factors, when calculated, (a) minimize a distance between the final estimation and the targets and (b) minimize a distance between sets of initial weights and final trip weights. The tradeoff between these two is determined by the example budget parameter.

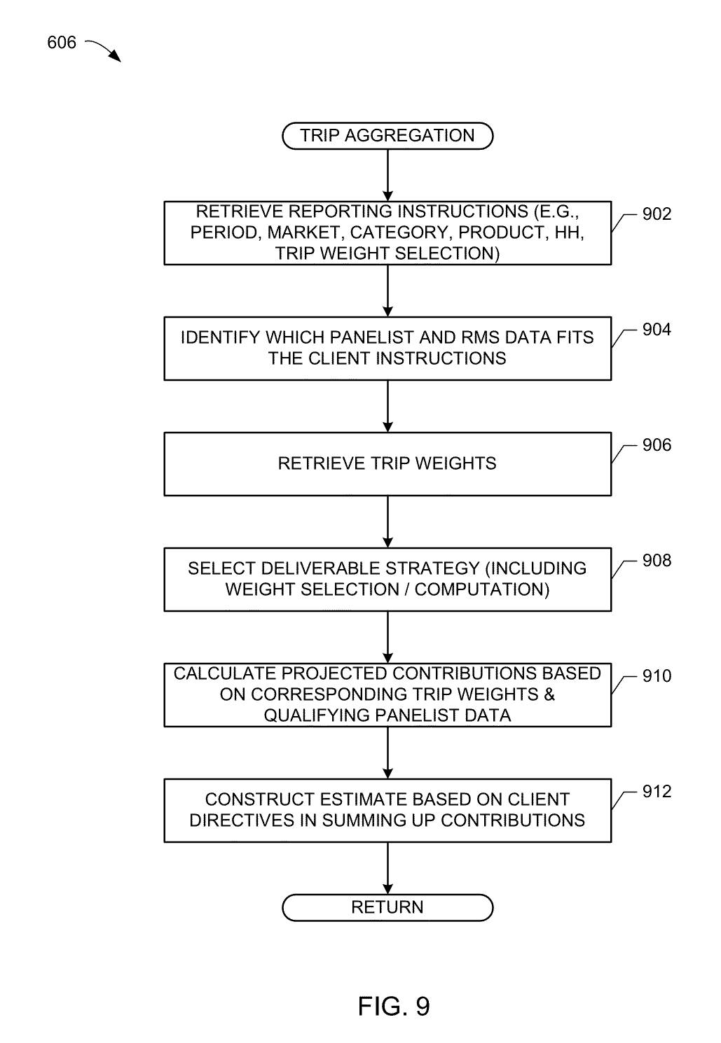

FIG. 9 illustrates block 606 from FIG. 6 in greater detail. In the illustrated example of FIG. 9, the example aggregation data interface 502 retrieves reporting instructions from the example reporting instruction storage 110 (block 902) and the example trip factor selection/computation engine 504 determines which panelist and RMS data best fits the example reporting instruction directives (block 904). The example reporting instructions reflect, for example, a period of interest, a market of interest, a category of interest, a product of interest or a household classification of interest. The example aggregation data interface 502 also retrieves trip weights from the example initial weight data storage 114 (block 906). The example trip factor selection/computation determines/selects a deliverable strategy (block 908). Based on the client directives, the example estimate constructor 506 calculates projected contributions based on corresponding trip weights and qualifying panelist data (block 910). The sum of the contributions of the volumetric data are then prepared and stored in the example trip weighted volumes and occasions storage 123. The example estimate constructor also constructs an estimate (block 1010) based on the client directives.

FIG. 10 is a block diagram of an example processor platform 1000 capable of executing the instructions of FIGS. 6-9 to implement the system 100 of FIG. 1. The processor platform 1000 can be, for example, a server, a personal computer, an Internet appliance, or any other type of computing device.

The system 1000 of the instant example includes a processor 1012. For example, the processor 1012 can be implemented by one or more microprocessors or controllers from any desired family or manufacturer.

The processor 1012 includes a local memory 1013 (e.g., a cache) and is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 also includes an interface circuit 1020. The interface circuit 1020 may be implemented by any type of interface standard, such as an Ethernet interface, a universal serial bus (USB), and/or a PCI express interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, isopoint and/or a voice recognition system.

One or more output devices 1024 are also connected to the interface circuit 1020. The output devices 1024 can be implemented, for example, by display devices (e.g., a liquid crystal display, a cathode ray tube display (CRT), a printer and/or speakers). The interface circuit 1120, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The processor platform 1000 also includes one or more mass storage devices 1028 for storing software and data. Examples of such mass storage devices 1028 include floppy disk drives, hard drive disks, compact disk drives and digital versatile disk (DVD) drives.

The coded instructions 1032 of FIGS. 6-9 may be stored in the mass storage device 1028, in the volatile memory 1014, in the non-volatile memory 1016, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to align market data sources, comprising:
calculating a panelist reporting period for a panelist dataset having a first number of occasions, the panelist dataset having a household resolution;
applying trip weights to a retailer dataset, the retailer dataset including a second number of occasions during a market research reporting period, the retailer dataset having a trip resolution; and
minimizing a gap between the household resolution and the trip resolution.

2. A method as defined in claim 1, further comprising identifying a compliance metric for panelist households within the panelist dataset during the market research reporting period.

3. A method as defined in claim 2, further comprising weighting ones of the panelist households based on a number of compliant sub-durations of the market research reporting period.

4. A method as defined in claim 3, further comprising a household weighting factor to calculate weighting of the one of the panelist households.

5. A method as defined in claim 1, wherein the first number of occasions is lower than the second number of occasions due to panelist reporting compliance metrics.

6. A method as defined in claim 1, wherein calculating the panelist reporting period further comprises generating period-weighted consumer facts.

7. A method as defined in claim 6, wherein applying trip weights to the retailer dataset further comprises generating trip-calibrated facts.

8. A method as defined in claim 7, further comprising applying a negative binomial distribution to minimize the gap between the household resolution and the trip resolution.

9. An apparatus to align market data sources, comprising:
a period weighting engine to calculate a panelist reporting period for a panelist dataset having a first number of occasions, the panelist dataset having a household resolution;
a trip calibration engine to apply trip weights to a retailer dataset, the retailer dataset including a second number of occasions during a market research reporting period, the retailer dataset having a trip resolution; and
an alignment engine to minimize a gap between the household resolution and the trip resolution.

10. An apparatus as defined in claim 9, further comprising a period counter to identify a compliance metric for panelist households within the panelist dataset during the market research reporting period.

11. An apparatus as defined in claim 10, further comprising an average household factor computation engine to weight ones of the panelist households based on a number of compliant sub-durations of the market research reporting period.

12. An apparatus as defined in claim 11, wherein the average household factor computation engine is to calculate weighting of the one of the panelist households.

13. An apparatus as defined in claim 9, further comprising a period weighting engine to generate period-weighted consumer facts.

14. An apparatus as defined in claim 13, wherein the period weighting engine comprises a negative binomial distribution engine.

15. A tangible machine readable storage medium comprising instructions stored thereon that, when executed, cause a machine to, at least:
calculate a panelist reporting period for a panelist dataset having a first number of occasions, the panelist dataset having a household resolution;
apply trip weights to a retailer dataset, the retailer dataset including a second number of occasions during a market research reporting period, the retailer dataset having a trip resolution; and
minimize a gap between the household resolution and the trip resolution.

16. A machine readable storage medium as defined in claim 15, wherein the instructions, when executed, cause the machine to identify a compliance metric for panelist households within the panelist dataset during the market research reporting period.

17. A machine readable storage medium as defined in claim 16, wherein the instructions, when executed, cause the machine to weight ones of the panelist households based on a number of compliant sub-durations of the market research reporting period.

18. A machine readable storage medium as defined in claim 17, wherein the instructions, when executed, cause the machine to calculate weighting of the one of the panelist households with a household weighting factor.

19. A machine readable storage medium as defined in claim 15, wherein the instructions, when executed, cause the machine to generate period-weighted consumer facts.

20. A machine readable storage medium as defined in claim 19, wherein the instructions, when executed, cause the machine to generate trip-calibrated facts when applying trip weights to the retailer dataset.
